(19) United States
(12) Patent Application Publication
(10) Pub. No.: US 2004/0054101 A1
(43) Pub. Date: Mar. 18, 2004

(54) Method for preparing a catalyst support for polymerising ethylene and a-olefins, resulting support and corresponding catalyst

(76) Inventors: Thierry Saudemont, Bruxelles (BE); Jean Malinge, Saint-Genis Laval (FR); Jean-Loup Lacombe, Pau (FR)

Correspondence Address: Smith Gambrell & Russell, 1850 M Street N W, Suite 800, Washington, DC, 20036, US

(21) Appl. No.: 10/343,239

(22) PCT Filed: Aug. 2, 2001
(86) PCT No.: PCT/FR01/02529

(30) Foreign Application Priority Data
Aug. 3, 2000 (FR) 00/10264

(51) Int. Cl. C08F 4/44; B01J 31/00

(52) U.S. Cl. 526/125.3; 526/351; 502/102; 502/103; 502/114; 502/115; 502/118; 502/121; 502/122; 502/123; 502/125; 502/126; 502/128

(57) ABSTRACT

This process for preparing a catalyst support for the homopolymerization or copolymerization of ethylene and α-olefins is characterized in that at least one organochlorine compound and a premix of at least one alkylmagnesium and of at least one organoaluminum compound chosen from aluminoxanes, aluminosiloxanes and alkylaluminums are reacted together, in the presence of at least one aliphatic diether as electron donor.

The present invention relates to a process for preparing a catalyst support for the polymerization of ethylene and the (stereospecific) polymerization of α-olefins, in particular propylene, and also to the support thus obtained. The invention also relates to the corresponding catalyst (support+compound based on transition metal+, where appropriate, electron donor or internal Lewis base) or to the corresponding catalytic system (catalyst+cocatalyst+, where appropriate, electon donor or external Lewis base), and also to the polymerization process using this catalyst or this catalytic system.

The polymerization of ethylene and α-olefins is generally performed using catalysts of Ziegler-Natta type. The catalytic system of the Ziegler-Natta type generally consists of two indissociable elements: a catalytic component based on transition metal deposited on a support based on magnesium chloride and a cocatalyst generally based on an aluminum compound.

Numerous patents describe these catalytic components and their supports. Mention will be made herein only of fourth-generation catalysts of Ziegler-Natta type which generally consist of a crystalline magnesium chloride support on which are dispersed titanium chloride and an electron-donating compound, or internal Lewis base, which serves to obtain an isotactic polypropylene.

This electron donor is very often an aromatic dicarboxylic acid diester, as described in European patent application EP-A-45 976; it may also be a diether, as described in European patent application EP-A-361 494.

In the preparation of fourth-generation catalysts, this electron donor and the titanium compound are placed in contact with magnesium chloride in active form.

Many patents have been filed regarding the use of this type of catalyst in the presence of trialkylaluminum and of a second electron donor, referred to as an external Lewis base (for example silane), to perform the stereospecific polymerization of olefins. However, there are also patents that propose the use of only one of the two electron donors, namely the internal electron donor (EP-A-0 361 494).

The drawbacks of the current systems are especially the following:

Catalysts of Ziegler-Natta type often contain phthalates as internal Lewis bases, these phthalates usually having an influence on the stereospecificity of the final polymer. However, phthalates are compounds suspected of being hazardous to the health; it is thus advantageous to be able to do without them or to find substituents for them.

The preparation of catalytic systems for the polymerization of olefins (propylene) is relatively complex; a polymerization without external Lewis base might be a source for reducing the costs and would also allow a simplification of the process.

The molecular masses of the polymers are controlled during polymerization by the presence of a transfer agent, such as hydrogen. For many applications, there is a requirement for products that have relatively low molecular masses. The production of such products requires a large amount of transfer agent during polymerization. For process and cost reasons, it may be advantageous to have available a catalytic system that requires less hydrogen to manufacture the polymers of low molecular mass.

The Applicant Company has now discovered, surprisingly, that the magnesium chloride support can be manufactured by chlorination of an organomagnesium (alkylmagnesium) reagent in the presence of an organoaluminum compound and an aliphatic diether, in which case it is not necessary to use an internal electron donor (or internal Lewis base) during the activation of the support with the transition metal compound. It is thus possible to dispense with phthalates, which have become suspect in terms of dietary acceptability.

The Applicant Company has also discovered that the catalytic system of the invention requires less hydrogen to manufacture polymers of low molecular mass.

Moreover, the synthesis of Ziegler-Natta catalysts may be simplified since it is no longer necessary to use the internal Lewis base. The invention also offers the additional advantage that the external Lewis base may also be dispensed with.

French patent application No. 99-10129 filed on Aug. 4, 1999, in the name of the Applicant Company (not yet published at the time of filing of the present patent application) describes a process for preparing a catalyst support for the polymerization of α-olefins, comprising the steps of:

(i) reacting, in the presence of a complexing agent, an organochlorine compound and a mixture of an alkylmagnesium reagent and an organoaluminum compound; and

(ii) activating the product obtained with an activating electron donor (cyclic monoether).

The complexing agent is advantageously chosen from aliphatic or cyclic ethers, diisoamyl ether and sec-butyl ether being preferred.

In accordance with the present invention, the process for preparing the support does not involve step (ii) above, and the complexing agent is restricted to the family of aliphatic diethers, which makes it possible to obtain a highly isotactic polymer (for example polypropylene), in contrast with other complexing agents, without necessarily having to add an internal or external Lewis base.

According to the invention, the aliphatic diether is not placed in contact with magnesium chloride in active form, as in the case of European patent application EP-A-0 361 494 in which diethers are described, but is placed in contact with the alkylmagnesium before synthesizing the activated magnesium chloride support. In other words, according to EP-A-0 361 494, the diether is added after preparing the support, and, according to the present invention, the diether is added during the preparation of the support; this affords the advantage that, for a given melt flow index, the polymerization consumes less hydrogen, which also amounts to stating that, for a given amount of hydrogen, the polymer obtained is more fluid in the melt. Comparative examples demonstrating this effect have been carried out.

A first subject of the present invention is thus a process for preparing a catalyst support for the homopolymerization of α-olefins and ethylene, in particular for the homopolymerization of propylene or for the copolymerization of ethylene and α-olefins, characterized in that at least one organochlorine compound and a premix of at least one alkylmagnesium and of at least one organoaluminum compound chosen from aluminoxanes, aluminosiloxanes and alkylaluminums are reacted together, in the presence of at least one aliphatic diether as electron donor.

The aliphatic diether, the electron donor, acts as an agent for controlling the morphology of the support, which means that:

a) the SPAN (measurement defined specifically below, which characterizes the particle size distribution width of the support) is low, generally less than 5;

b) the polymer particles obtained by the processes of polymerization in suspension, gas phase in the liquid monomer, show a good morphological replica of the solid catalytic component obtained from the support and thus of the support itself.

At least one monoether chosen from aliphatic monoethers and cyclic monoethers may be combined with the aliphatic diether(s).

Also, the said premix may be combined with at least one aliphatic diether, as electron donor, and at least one monoether chosen from aliphatic monoethers and cyclic monoethers may be also be combined with this or these aliphatic diether(s).

The aliphatic diether(s) is (are) chosen especially from:

2,2-diisobutyl-1,3-dimethoxypropane;

2,2-diisobutyl-1,3-diethoxypropane;

2-isopropyl-2-isobutyl-1,3-dimethoxypropane;

2-isopropyl-2-cyclohexyl-1,3-dimethoxypropane;

2-isopropyl-2-cyclopentyl-1,3-dimethoxypropane;

2,2-dicyclopentyl-1,3-dimethoxypropane; and

9,9-bis(methoxymethyl)fluorene.

In particular, the aliphatic diether is 2,2′-dicyclopentyl-1,3-dimethoxypropane or 9,9-bis(methoxy-methyl)fluorene.

The aliphatic monoether(s) is (are) chosen especially from diisoamyl ether and di-sec-butyl ether, and the cyclic monoethers are chosen especially from tetrahydrofuran and dioxane.

The diether(s) and the monoether(s) combined with the premix and those used during the reaction of the organochlorine compound(s) and of the aluminum compound(s) may, respectively, be identical or different.

The organochlorine compound(s) is (are) chosen especially from:

alkyl chlorides in which the alkyl radical is primary, secondary or tertiary and optionally comprises a hetero atom, said radical containing up to 12 carbon atoms;

polyalkyl halides; and

acid chlorides.

Examples of organochlorine compounds that may be mentioned include tert-butyl chloride, n-butyl chloride, thionyl chloride, benzoyl chloride and dichloroethane.

The alkylmagnesium(s) is (are) chosen especially from those of formula (I):

R¹—Mg—R² (I)

in which R¹ and R² each independently represent an alkyl radical containing from 1 to 12 carbon atoms.

An alkylmagnesium reagent that is particularly preferred is butylethylmagnesium.

The aluminoxane(s) is (are) chosen especially from the compounds of formula (II):

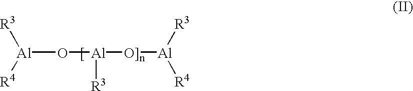

in which:

R³ represents a C₁-C₁₆ alkyl radical;

the radicals R⁴ together form a radical —O— or each represent a radical R³; and

n is 0 or is an integer from 1 to 20.

The aluminosiloxane(s) is (are) chosen especially from the compounds of formula (III):

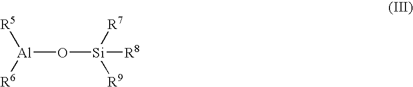

in which R⁵, R⁶, R⁷, R⁸ and R⁹, which may be identical or different, each represent a C₁-C₁₂ and preferably C₁-C₆ alkyl radical, or alternatively a hydrogen atom, with the condition that there are not more than 3 hydrogen atoms per mole of compound, or alternatively a chlorine atom, with the condition that there are not more than 3 chlorine atoms per mole of compound.

The alkylaluminum(s) is (are) chosen especially from the compounds of formula (IV):

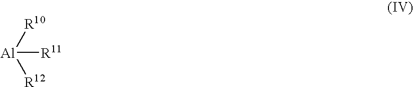

in which R¹⁰, R¹¹ and R¹², which may be identical or different, each represent an alkyl radical containing from 1 to 12 carbon atoms and preferably from 1 to 6 carbon atoms.

In order to correctly control the morphology of the final support, it is important to combine the components together in suitable amounts. Thus, the Mg/Al molar ratio is advantageously between 5 and 200 and preferably between 10 and 80. Moreover, the concentration of organochlorine compound(s) is advantageously such that the Cl/Mg molar ratio is between 2 and 4.

The molar ratio of the total amount of aliphatic diether(s) and of monoether(s) to magnesium is advantageously at least 0.01 and in particular from 0.01 to 5, the aliphatic diethers being those used with the organochlorine compound(s) and optionally with the premix, and the monoethers being those optionally used with the organochlorine compound(s) and/or with the premix.

In accordance with one preferred embodiment, the molar ratio of the total amount of aliphatic diether(s), excluding monoethers, to magnesium is at least 0.01 and in particular from 0.01 to 5, the aliphatic diethers being those used with the organochlorine compound(s) and optionally with the premix, and the monoethers being those optionally used with the organochlorine compound(s) and/or with the premix.

In accordance with one particular embodiment of the process for manufacturing the support according to the invention:

in a first step, the alkylmagnesium(s) is (are) mixed with the organoaluminum compound(s) in the presence of the aliphatic diether(s) and, where appropriate, of the aliphatic or cyclic monoether(s), this reaction possibly being advantageously performed in an inert solvent such as a hydrocarbon containing from 6 to 30 carbon atoms, which may be chosen from linear or cyclic, saturated or unsaturated hydrocarbons, for instance heptane, cyclohexane, toluene, benzene or derivatives thereof such as durene or xylene, and any mixture of these compounds;

in a second step, the organochlorine compound(s) diluted in the aliphatic diether(s) and, where appropriate, the aliphatic or cyclic monoether(s) are reacted together, where appropriate in an inert solvent such as those indicated in the first step; and

at the end of the reaction, the support thus formed suspended in the reaction medium is filtered off and washed with an inert liquid, which may be chosen from the inert solvents identified above.

A support is thus obtained with a particle diameter of between 5 and 150 μm and more generally between 5 and 100 μm. The particle size distribution width of the support, and consequently of the subsequent catalyst, is very narrow and in general less than 5.

A subject of the present invention is also a catalyst support for the homopolymerization or copolymerization of ethylene and α-olefins, which may be obtained by the process as defined above.

A subject of the present invention is also a Ziegler-Natta catalyst for the homopolymerization of α-olefins and ethylene, in particular for the homopolymerization of propylene, or for the copolymerization of ethylene and α-olefins, comprising the catalyst support prepared or which may be obtained by the process as defined above, and at least one halide of a transition metal from group IV.

The halide of a transition metal from group IV is especially a titanium halide of formula (V):

Ti(OR¹³)ₚX₄₋ₚ (V)

in which:

R¹³ is a C₁-C₁₂ alkyl radical;

X represents a halogen; and

p represents an integer between 0 and 4.

Preferably, the titanium halide is TiCl₄.

The catalyst may also comprise at least one (“impregnating”) electron donor advantageously chosen from organic compounds containing one or more nitrogen, sulfur or phosphorus atoms. Examples that may be mentioned include organic acids, organic acid esters, alcohols, ethers, aldehydes, ketones, amines, amine oxides, amides and thiols. The combination of one or more of the above electron donors may be performed. More specifically, the electron donors containing one or more oxygen atoms that are commonly used may be organic acid esters or ethers. More specifically, they may be aromatic monocarboxylic or dicarboxylic acid esters or diethers. Examples that may be mentioned include 2,2-diisobutyl-1,3-dimethoxypropane, 2,2-diisobutyl-1,3-diethoxypropane, 2-isopropyl-2-isobutyl-1,3-dimethoxypropane, 2-isopropyl-2-cyclohexyl-1,3-dimethoxypropane; 2-isopropyl-2-cyclopentyl-1,3-dimethoxypropane, 2,2-dicyclopentyl-1,3-dimethoxypropane and 9,9-bis(methoxymethyl)fluorene. The aromatic esters may be phthalates such as dialkyl phthalates, but the invention also relates to a catalyst as defined above from which the phthalates are excluded, and also to a catalyst as defined above from which, in general, the nonether internal Lewis bases are excluded.

The present invention also relates to a process for preparing a catalyst as defined above, characterized in that it comprises the impregnation of the support prepared or which may be prepared by the process as defined above, with at least one halide of a transition metal, where appropriate in the presence of at least one impregnating electron donor, and, where appropriate, in the presence of an inert solvent.

The impregnation may thus take place conventionally by adding to the support a sufficient amount of transition metal halide(s) optionally in an inert solvent to form a homogeneous suspension, and optionally in the presence of the electron donor. The support may optionally undergo two or more successive impregnations with the transition metal halide(s).

Inert solvents that may be used include aliphatic hydrocarbons such as hexane, heptane and decane; alicyclic hydrocarbons such as cyclohexane and ethylcyclohexane; aromatic hydrocarbons such as toluene, xylene, chlorobenzene and durene, and mixtures thereof.

The catalyst thus prepared is combined with a cocatalyst to perform the polymerization of olefins. The present invention thus also relates to a catalytic system for the homopolymerization or copolymerization of ethylene and α-olefins, characterized in that it comprises a catalyst as defined above and at least one cocatalyst and, where appropriate, at least one cocatalytic electron donor.

The cocatalyst is generally chosen from alkyls of metals from group III, among which mention may be made of alkylaluminums, for instance trimethylaluminum, triethylaluminum and triisobutylaluminum, and combinations thereof.

The cocatalytic electron donor(s) that may be used to modify the catalytic performance qualities may advantageously be chosen from:

aliphatic silanes of general formula (VI)

SiR¹⁴₄ (VI)

in which the radicals R¹⁴ each independently represent a C₁-C₂₀ alkyl group or an alkoxy group —OR¹⁵, R¹⁵ representing a C₁-C₂₀ alkyl group (examples that may be mentioned include dicyclopentyldimethoxysilane, cyclohexylmethyl-dimethoxysilane and diisobutyldimethoxysilane);

arylalkoxysilanes such as diphenyldimethoxysilane, phenylmethyldimethoxysilane, phenylethyldimethoxysilane and phenyltrimethoxysilane;

silacycloalkanes such as 2,6-diethylsilacyclo-hexane;

diethers of general formula (VII):

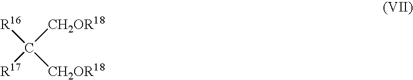

in which R¹⁶, R¹⁷ and R¹⁸, which may be identical or different, each represent a C₁-C₂₀ alkyl group (examples that may be mentioned include 2,2-diisobutyl-1,3-dimethoxypropane, 2,2-diisobutyl-1,3-diethoxypropane, 2-isopropyl-2-isobutyl-1,3-dimethoxypropane, 2-isopropyl-2-cyclopentyl-1,3-dimethoxypropane, 2,2-dicyclopentyl-1,3-dimethoxypropane and 9,9-bis(methoxymethyl)fluorene and combinations of these compounds); and

aminosilanes of general formulae (VIII) and (IX):

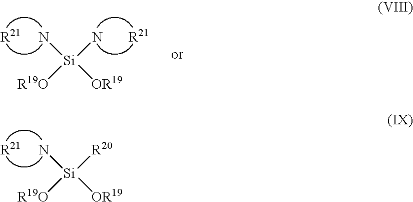

in which:

R¹⁹ represents an alkyl group containing from 1 to 8 carbon atoms;

R²⁰ represents an alkyl group containing from 2 to 24 carbon atoms and preferably from 2 to 8 carbon atoms, or a hydrocarbon-based amine group containing from 2 to 20 carbon atoms or an alkoxy group containing from 2 to 24 carbon atoms and preferably from 2 to 8 carbon atoms, or alternatively a hydrocarbon-based silicon group; and

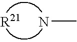

represents a polycyclic amino group for which the number of carbon atoms is between 7 and 40, and which forms a cyclic skeleton including the nitrogen atom.

The present invention also relates to a process for the homopolymerization of α-olefins and ethylene, in particular for the homopolymerization of propylene, or for the copolymerization of ethylene and α-olefins, which involves placing ethylene and/or at least one α-olefin and/or of at least one other comonomer representing less than 50% by mass, in contact with a catalytic system as defined above, said process being performed in suspension or in the gas phase or in a liquid α-olefin.

The invention thus applies to the polymerization of ethylene and to the stereospecific polymerization of α-olefins and more particularly propylene, and to the copolymerization of ethylene and α-olefins. The copolymerization also encompasses terpolymerization. In the copolymerization, ethylene and α-olefins may be copolymerized together; the process may also be performed with another comonomer, in which case it represents less than 50% by mass of the monomers as a whole.

The term “α-olefin” as used in the invention is directed toward olefins containing from 3 to 20 carbon atoms and preferably from 3 to 8 carbon atoms. The preferred α-olefin is propylene. In the case of propylene copolymers, for example with ethylene or butene, the comonomer represents in general less than 30% by mass. In addition to the stereospecific polymers that may be produced with the catalytic system according to the invention, said system also makes it possible to produce, with high production efficiency, nonstereospecific polymers, for instance α-olefin random polymers with a high content of comonomer such as ethylene.

The polymerization of α-olefins may be performed according to the known processes, in suspension in a diluent, in the liquid monomer or in the gas phase. A chain-transfer agent may be used to control the melt flow index of the polymer to be produced. A chain-transfer agent that may be used is hydrogen, which is introduced in an amount that may be up to 90% and is generally between 0.01 mol % and 60 mol % of the combination of olefin and hydrogen introduced into the reactor. This chain-transfer agent allows a given melt flow index to be obtained, given that the melt flow index increases when the amount of chain-transfer agent increases. The invention offers the advantage of consuming little chain-transfer agent for a given melt flow index.

The examples that follow illustrate the invention without, however, limiting its scope. In these examples, the percentages are given on a weight basis except where otherwise mentioned, and the following abbreviations have been used:

| | |
|---|---|
| BEM | butylethylmagnesium |
| DCPDMP | 2,2-dicyclopentyl-1,3-dimethoxypropane |
| TiBAO | tetraisobutylaluminoxane |
| DIAE | dilsoamyl ether |
| THF | tetrahydrofuran |
| TEA | triethylaluminum |
| Durene | tetramethylbenzene |

All the manipulations were performed under a nitrogen atmosphere.

The melt flow index (MFI) is defined according to ASTM

standard D 1238.

The SPAN measurement characterizes the particle size distribution width, where the SPAN is equal to (D90-D10)/D50 in which D90, D10 and D50 represent the diameter below which 90%, 10% and 50% by weight, respectively, of the particles are found.

The % mm, measured by high resolution ¹³C NMR, defines the percentage of meso triads in the polymer obtained.

### EXAMPLE 1

Synthesis of the Support

135 g of a solution consisting of 20% by mass (0.24 mol) of BEM in heptane, 1.0 g (0.0042 mol) of DCPDMP and 9.16 g (0.006 mol) of a solution of TiBAO at 20% by mass in hexane are introduced into a 1 liter glass reactor equipped with a jacket, a mechanical stirrer, a condenser and tubing for introducing the reagents. This mixture is stirred for 1 hour at room temperature at 400 rpm. The temperature of the reaction medium is then raised to 50° C.

Under the same stirring conditions and at 50° C., a mixture consisting of 56.8 g (0.61 mol) of tert-butyl chloride and 9.0 g (0.0378 mol) of DCPDMP is introduced, using a syringe, at a flow rate of 35 ml/h. After this introduction, the stirring and the temperature are maintained at the above values for two hours. The suspension thus obtained is filtered and then stored in 100 ml of hexane. The support A1 is obtained.

D50=10.0 μm, SPAN=1.6.

Synthesis of the Catalyst

10 g of solid A1 are suspended in 30 ml of toluene at room temperature with stirring (250 rpm). 89 ml of TiCl₄ are added. The temperature is raised to 100° C. over 10 minutes and maintained at this temperature for 2 hours.

After filtration, 7 ml of TiCl₄ and 123 ml of toluene are added and the mixture is stirred at 100° C. for 1 hour. This operation is repeated 4 times.

After the final filtration, 200 ml of hexane are added and the mixture is stirred for 15 minutes at 70° C. This last operation is repeated twice.

After the final filtration, the solid is dried for 2 hours at 70° C.

13.9 g of a catalyst B1 containing 15.6% DCPDMP, 1.7% titanium and 17.6% magnesium are obtained. The D50 is 8.6 μm for a SPAN of 1.3.

Polymerization

4×10⁴ Pa (0.4 bar) of hydrogen and 6 liters of propylene are introduced into an 8 liter metal reactor, equipped with a jacket and a mechanical stirrer, and placed beforehand under an inert atmosphere. 21 mmol of TEA and 39.2 mg of catalyst B1 are introduced at room temperature, with stirring. The temperature is raised to 70° C. over ten minutes and then maintained at this value for 1 hour.

The residual propylene is then degassed off to give 836 g of polypropylene—i.e. 21 300 g of polypropylene/g of catalyst B1—with a melt flow index of 45 g/10 minutes and a % mm of 96.5.

D50=285 μm, SPAN=1.2.

### EXAMPLE 2

The process is performed as in example 1, except that 0.21 mol of dicyclopentyldimethoxysilane is introduced in the polymerization step with the 21 mmol of TEA and 40.6 mg of catalyst B1.

1 000 g of polymer are recovered—i.e. 24 600 g of polypropylene/g of catalyst B1—with a melt flow index of 6.2 g/10 minutes and a % mm of 97.6.

D50=268 μm; SPAN=1.2.

### Comparative Example 3

The process is performed as in example 1, except that the 10 g of DCPDMP are replaced with 3.9 g of diisoamyl ether, 10% of which are used with the BEM and 90% of which are used with the tert-butyl chloride.

105 Pa (1 bar) of hydrogen and 3.5 liters of propylene are introduced into a 4.5 liter metal reactor equipped with a jacket and a mechanical stirrer, and placed beforehand under an inert atmosphere. 24 mmol of triethylaluminum and 15 mg of catalyst B1 are introduced at room temperature, with stirring. The temperature is raised to 70° C. over ten minute and then maintained at this value for 1 hour.

The residual propylene is then degassed off to give 21 g of polypropylene—i.e. 1 273 g of polypropylene/g of catalyst B1. The melt flow index cannot be measured on account of the excessive fluidity of the polymer. The % mm is 70.1.

### EXAMPLE 4

Synthesis of the Support

100 g of a solution consisting of 20% (0.18 mol) of BEM in heptane, 0.48 g (2×10⁻³ mol) of DCPDMP and 4.52 g of a solution consisting of 20% (3×10⁻³ mol) of TiBAO in hexane are introduced into a 1 liter reactor equipped with a jacket, a mechanical stirrer and tubing for introducing the reagents. This mixture is stirred for 1 hour. At the same time, the temperature is raised to 50° C. and the stirring is continued at 250 rpm.

A mixture consisting of 42.1 g (0.45 mol) of tert-butyl chloride and 4.32 g (18−10⁻³ mol) of DCPDMP is introduced, under the same stirring and temperature conditions, using a syringe, at a flow rate of 25 ml/h. After this introduction, the stirring and the temperature are maintained at the above values for 15 minutes. The suspension obtained is filtered and the solid is then washed three times at 50° C. with 100 cm³ of hexane. The support A2 is obtained.

Synthesis of the Catalyst

10.4 g of solid A2 are suspended in 30 ml of toluene at room temperature with stirring (250 rpm). 90 ml of TiCl₄ are added. The temperature is raised to 100° C. over 10 minutes and maintained at this temperature for 2 hours.

After filtration, 129 ml of toluene and 7 ml of TiCl₄ are added and the mixture is stirred at 100° C. for 1 hour. This operation is repeated 4 times.

After the final filtration, 104 ml of hexane are added and the mixture is stirred for 15 minutes at 70° C. This last operation is repeated twice.

After filtration, the solid is dried for 2 hours at 70° C. 8 g of a catalyst B2 containing 12.0% DCPDMP, 1.4% Ti and 18.5% Mg are obtained. The D50 is 17.0 μm for a SPAN of 1.6.

Polymerization

7×10⁴ Pa (0.7 bar) of hydrogen and 2.5 liters of propylene are introduced into a 3.4 liter metal reactor, equipped with a jacket and a mechanical stirrer, and placed beforehand under an inert atmosphere. 24 mmol of TEA and 20 mg of catalyst B2 are introduced at room temperature, with stirring. The temperature is raised to 70° C. over ten minutes and then maintained at this value for 1 hour.

The propylene is then degassed off to give 468 g of polymer—i.e. 23 400 g of polypropylene/g of catalyst B2—with a melt flow index of 22.3 g/10 minutes. The % mm is 96.0.

### EXAMPLE 5

Synthesis of the Support

150 g of a solution consisting of 20% (0.27 mol) of BEM in heptane, 2.1 g of a mixture consisting of 7.2 g (3×10⁻³ mol) of DCPDMP and 13.77 g of THF, and finally 6.78 g of a solution consisting of 20% (4.5×10⁻³ mol) of TiBAO in hexane, are introduced into a 1 liter reactor, equipped with a jacket, a mechanical stirrer and tubing for introducing the reagents.

This mixture is stirred for 1 hour. At the same time, the temperature is raised to 50° C. and the stirring is continued at 250 rpm.

A solution consisting of 64.0 g (0.68 mol) of tert-butyl chloride and 18.87 g of the above DCPDMP/THF mixture is introduced, under the same stirring and temperature conditions, using a syringe, at a flow rate of 25 ml/h. After this introduction, the stirring and the temperature are maintained at the above values for 15 minutes. The suspension obtained is filtered and the solid is then washed three times at 50° C. with 150 cm³ of hexane. The support A3 is obtained.

Synthesis of the Catalyst

The synthesis of the catalyst is identical to that of example 4, the support A2 being replaced with the support A3. 7.7 g of catalyst B3 containing 15.4% DCPDMP, 2.5% Ti and 17.0% Mg are recovered. The D50 is 20.0 μm for a SPAN of 0.9.

Polymerization

The polymerization of propylene is identical to that of example 4, the catalyst B2 being replaced with the catalyst B3. 535 g of polymer are recovered—i.e. 26 800 g of polypropylene/g of catalyst B3—with a melt flow index of 25.8 g/10 minutes. The % mm is 92.7.

### Comparative Example 6

Synthesis of the Support

200 g (0.36 mol) of BEM at 20% in heptane, 2.5 g of diisoamyl ether and 9.05 g of a 20% solution of TiBAO in hexane are introduced into a 1 liter glass reactor equipped with a jacket, a mechanical stirrer and tubing for introducing the reagents.

This mixture is stirred for 1 hour at room temperature at 400 rpm; the temperature of the reaction medium is then raised to 50° C.

A mixture consisting of 84.4 g of tert-butyl chloride and 23.3 g of diisoamyl ether is introduced, under the same stirring conditions and at 50° C., using a syringe, at a flow rate of 60 ml/h. After this introduction, the temperature is brought down to 40° C. and the stirring speed is lowered to 250 rpm. 50.9 g of THF are introduced, using a syringe, at a flow rate of 60 ml/h. After this addition, the medium is maintained at 40° C. with stirring for 15 minutes. The suspension is then filtered and the recovered solid is washed three times with 200 ml of hexane each time. A filtration is performed after each wash. A solid A4 is obtained.

Synthesis of the Catalyst

317 ml of TiCl₄ are introduced into a 1 liter round-bottomed flask equipped with a condenser, a mechanical stirrer and a thermometer, under a nitrogen atmosphere.

12.3 g of the support A4 are introduced at 20° C. with stirring, and the mixture is heated to 100° C. over 50 minutes.

When the temperature reaches 40° C., 1.98 g of DCPDMP are introduced. The system is maintained at 100° C. for 2 hours.

After filtration, 280 ml of TiCl₄ are introduced onto the solid, and the mixture is then heated at 120° C. for 1 hour with stirring. After filtration, the solid is washed 6 times with 100 ml of hexane at 60° C. and 3 times at room temperature, and then dried for 2 hours at 70° C. The catalyst B4 is obtained.

Catalyst B4 contains 2.9% Ti, 14.4% DCPDMP and 17.5% Mg.

Polymerization

The polymerization of propylene was performed in a manner identical to that of example 4, using the solid B4 instead of the solid B2. 767 g of polymer are recovered—i.e. 38 400 g of polypropylene/g of catalyst B4—with a melt flow index of 10.1 g/10 minutes. The % mm is 91.3.

### EXAMPLE 7

The process is performed in the same manner as in example 4, except that 1.2×10⁻³ mol of dicyclo-pentyldimethoxysilane are added with the TEA in the polymerization stage.

430 g of polymer are recovered—i.e. 21 500 g of polypropylene/g of catalyst B2—with a melt flow index of 14.1 g/10 minutes. The % mm is 95.8.

### EXAMPLE 8

The process is performed in the same manner as in example 5, except that 1.2×10⁻³ mol of dicyclopentyldimethoxysilane are added with the TEA in the polymerization stage.

401 g of polymer are recovered—i.e. 20 100 g of polypropylene/g of catalyst B3—with a melt flow index of 16.1 g/10 minutes. The % mm is 94.2.

### Example (Comparative) 9

The process is performed in the same manner as in comparative example 6, except that 1.2×10⁻³ mol of dicyclopentyldimethoxysilane are added with the TEA in the polymerization stage.

719 g of polymer are recovered—i.e. 36 000 g of polypropylene/g of catalyst B3—with a melt flow index of 8.6 g/10 minutes. The % mm is 94.4.

### Example 10

150 g of a solution consisting of 20% by mass (0.27 mol) of BEM in heptane, 2.1 g of a mixture consisting of 7.2 g (3×10⁻³ mol) of DCPDMP and 13.77 g of THF, and finally 6.78 g of a solution consisting of 20% by mass (4.5×10⁻³ mol) of TiBAO in hexane, are introduced into a 1 liter reactor equipped with a jacket, a mechanical stirrer and tubing for introducing the reagents.

This mixture is stirred for 1 hour. At the same time, the temperature is raised to 50° C. and the stirring is continued at 250 rpm.

A solution consisting of 64.0 g (0.68 mol) of tert-butyl chloride and 18.87 g of the above DCPDMP-THF mixture is introduced, under the same stirring and temperature conditions, using a syringe, at a flow rate of 25 ml/h. After this introduction, the stirring and the temperature are maintained at the above values for 15 minutes. The suspension obtained is filtered and the solid is then washed three times at 50° C. with 150 ml of hexane.

9 grams of the above solid suspended in 74.1 ml of hexane are stirred at 40° C. for 1 hour in the presence of 80 ml of toluene and 13.45 g of durene. The suspension is filtered and the solid is then washed three times at 40° C. with 80 cm³ of hexane.

The solid obtained is suspended in 23 ml of toluene at 40° C. with stirring (250 rpm). 70 ml of TiCl₄ are added. The temperature is raised to 100° C. over 5 minutes and maintained at this temperature for 2 hours. After filtration, 94 ml of toluene and 5 ml of TiCl₄ are added and the mixture is stirred at 100° C. for 1 hour. This operation is repeated 4 times. After the final filtration, 90 ml of hexane are added and the mixture is stirred for 15 minutes at 70° C. This last operation is repeated twice. After filtration, the solid is dried for 2 hours at 70° C. 5.5 g of catalyst B5 containing 12.8% dicyclopentyl-1,3-dimethoxypropene, 2.2% Ti and 19.2% Mg are obtained. The DP50 is 19.9 μm for a SPAN of 0.91.

The polymerization of propylene is equivalent to that of example 1, replacing the catalyst B1 with 30 mg of catalyst B5 and using 12.5 millimol of TEA instead of 21 millimol. The amount of hydrogen used is 7×10⁴ Pa (0.7 bar) instead of 4×10⁴ Pa (0.4 bar). 1 455 g of polypropylene are recovered—i.e. 48 500 g of polypropylene per gram of catalyst B5—with a melt flow index of 13.4 g/10 minutes and a % mm of 93.6.

1. A process for preparing a catalyst support for the homopolymerization of α-olefins and ethylene, in particular for the homopolymerization of propylene or for the copolymerization of ethylene and α-olefins, characterized in that at least one organochlorine compound and a premix of at least one alkylmagnesium and of at least one organoaluminum compound chosen from aluminoxanes, aluminosiloxanes and alkylaluminums are reacted together, in the presence of at least one aliphatic diether as electron donor.

2. The process as claimed in claim 1, characterized in that at least one monoether chosen from aliphatic monoethers and cyclic monoethers has been combined with the aliphatic diether(s).

3. The process as claimed in either of claims 1 and 2, characterized in that at least one aliphatic diether has been combined with said premix, as electron donor.

4. The process as claimed in claim 3, characterized in that at least one monoether chosen from aliphatic monoethers and cyclic monoethers has been combined with the aliphatic diether(s).

5. The process as claimed in one of claims 1 to 4, characterized in that the aliphatic diether(s) is (are) chosen from:
2,2-diisobutyl-1,3-dimethoxypropane;
2,2-diisobutyl-1,3-diethoxypropane;
2-isopropyl-2-isobutyl-1,3-dimethoxypropane;
2-isopropyl-2-cyclohexyl-1,3-dimethoxypropane;
2-isopropyl-2-cyclopentyl-1,3-dimethoxypropane;
2,2-dicyclopentyl-1,3-dimethoxypropane; and
9,9-bis(methoxymethyl)fluorene.

6. The process as claimed in claim 5, characterized in that the aliphatic diether is 2,2′-dicyclopentyl-1,3-dimethoxypropane or 9,9-bis(methoxymethyl)fluorene.

7. The process as claimed in claim 4, characterized in that the aliphatic monoether(s) is (are) chosen from diisoamyl ether and di-sec-butyl ether.

8. The process as claimed in claim 4, characterized in that the cyclic monoethers are chosen from tetrahydrofuran and dioxane.

9. The process as claimed in one of claims 1 to 8, characterized in that the organochlorine compound(s) is (are) chosen from:
alkyl chlorides in which the alkyl radical is primary, secondary or tertiary and optionally comprises a hetero atom, said radical containing up to 12 carbon atoms;
polyalkyl halides; and
acid chlorides.

10. The process as claimed in claim 9, characterized in that the organochlorine compound(s) is (are) chosen from tert-butyl chloride, n-butyl chloride, thionyl chloride, benzoyl chloride and dichloroethane.

11. The process as claimed in claims 1 to 10, characterized in that the alkylmagnesium(s) is (are) chosen from those of formula (I):
R¹—Mg—R² (I)
in which R¹ and R² each independently represent an alkyl radical containing from 1 to 12 carbon atoms.

12. The process as claimed in claim 11, characterized in that the alkylmagnesium reagent is butylethylmagnesium.

13. The process as claimed in one of claims 1 to 12, characterized in that:
the aluminoxane(s) is (are) chosen from the compounds of formula (II): 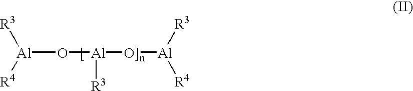
in which:
R³ represents a C₁-C₁₆ alkyl radical;
the radicals R⁴ together form a radical —O— or each represent a radical R³; and
n is 0 or is an integer from 1 to 20;
the aluminoxane (a) is (are) chosen from the compounds of formula (III): 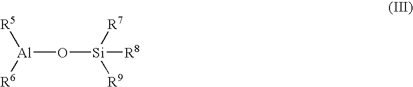
in which R⁵, R⁶, R⁷, R⁸ and R⁹, which may be identical or different, each represent a C₁-C₁₂ alkyl radical, or alternatively a hydrogen atom, with the condition that there are not more than 3 hydrogen atoms per mole of compound, or alternatively a chlorine atom, with the condition that there are not more than 3 chlorine atoms per mole of compound; and
the alkylaluminum(s) is (are) chosen from the compounds of formula (IV) 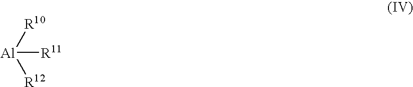
in which R¹⁰, R¹¹ and R¹², which may be identical or different, each represent an alkyl radical containing from 1 to 12 carbon atoms and preferably from 1 to 6 carbon atoms.

14. The process as claimed in one of claims 1 to 13, characterized in that the Mg/Al molar ratio is between 5 and 200.

15. The process as claimed in claim 14, characterized in that the Mg/Al molar ratio is between 10 and 80.

16. The process as claimed in one of claims 1 to 15, characterized in that the concentration of organochlorine compound(s) is such that the Cl/Mg molar ratio is between 2 and 4.

17. The process as claimed in one of claims 1 to 16, characterized in that the molar ratio of the total amount of aliphatic diether(s) and of monoether(s) to magnesium is at least 0.01, the aliphatic diethers being those used with the organochlorine compound(s) and optionally with the premix, and the monoethers being those optionally used with the organochlorine compound(s) and/or with the premix.

18. The process as claimed in claim 17, characterized in that said molar ratio is between 0.01 and 5.

19. The process as claimed in one of claims 1 to 17, characterized in that the molar ratio of the total amount of aliphatic diether(s), excluding monoethers, to magnesium is at least 0.01, the aliphatic diethers being those used with the organochlorine compound(s) and/or with the premix.

20. The process as claimed in claim 19, characterized in that said ratio is between 0.01 and 5.

21. The process as claimed in one of claims 1 to 20, characterized in that:
in a first step, the alkylmagnesium(s) is (are) mixed with the organoaluminum compound(s) in the presence of the aliphatic diether(s) and, where appropriate, of the aliphatic or aromatic monether(s), this reaction possibly being performed in an inert solvent;
in a second step, the organochlorine compound(s) diluted in the aliphatic diether(s) and, where appropriate, the aliphatic or aromatic monoether(s) are reacted together, where appropriate in an inert solvent; and
at the end of the reaction, the support thus formed suspended in the reaction medium is filtered off and washed with an inert liquid.

22. The process as claimed in claim 21, characterized in that the inert solvent of the first or second step and the inert solvent for washing at the end of the reaction are chosen independently from linear or cyclic, saturated or unsaturated C₆-C₃₀ hydrocarbons for instance heptane, cyclohexane, toluene, benzene or derivatives thereof such as durene or xylene, and any mixture of these compounds.

23. The process as claimed in one of claims 1 to 22, characterized in that it leads to a support with a particle diameter of between 5 and 150 μm, and with a particle size distribution width of less than 5.

24. A catalyst support for the homopolymerization of α-olefins and ethylene, in particular for the homopolymerization of propylene, or for the copolymerization of ethylene and α-olefins, which may be obtained by the process as defined in one of claims 1 to 23.

25. A catalyst for the homopolymerization or copolymerization of ethylene and α-olefins, comprising the catalyst support prepared by the process as defined in one of claims 1 to 23 or as defined in claim 24, and at least one halide of a transition metal from group IV.

26. The catalyst as claimed in claim 25, characterized in that the halide of a transition metal from group IV is a titanium halide of formula (V):
Ti(OR¹³)ₚX₄₋ₚ (V)
in which:
R¹³ is a C₁-C₁₂ alkyl radical;
X represents a halogen; and
p represents an integer between 0 and 4.

27. The catalyst as claimed in claim 26, characterized in that the titanium halide is TiCl₄.

28. The catalyst as claimed in either of claims 26 and 27, characterized in that it also comprises at least one “impregnating” electron donor.

29. The catalyst is claimed in claim 28, characterized in that the impregnating electron donor(s) is (are) chosen from organic compounds containing one or more nitrogen, sulfur or phosphorus atoms.

30. The catalyst as claimed in one of claims 25 to 27, characterized in that it does not comprise phthalate.

31. The catalyst as claimed in one of claims 25 to 27, characterized in that it does not comprise a nonether internal Lewis base.

32. A process for preparing a catalyst as defined in one of claims 25 to 30, characterized in that it comprises the impregnation of the support prepared by the process as defined in one of claims 1 to 22 or as defined in claim 24, with at least one halide of a transition metal, where appropriate in the presence of at least one impregnating electron donor, and, where appropriate, in the presence of an inert solvent.

33. The process as claimed in claim 32, characterized in that the inert solvent is chosen from aliphatic hydrocarbons, alicyclic hydrocarbons and aromatic hydrocarbons, and mixtures thereof.

34. The process as claimed in claim 33, characterized in that the inert solvent is chosen from hexane, heptane, decane, cyclohexane, ethylcyclohexane, toluene, xylene, chlorobenzene and durene, and mixtures thereof.

35. The process as claimed in one of claims 32 to 34, characterized in that no phthalate is used as electron donor.

36. The process as claimed in one of claims 32 to 34, characterized in that no impregnating electron donor is used.

37. A catalytic system for the homopolymerization or copolymerization of ethylene and α-olefins, characterized in that it comprises a catalyst as defined in one of claims 25 to 31 and at least one cocatalyst, and, where appropriate, at least one catalytic electron donor.

38. The catalytic system as claimed in claim 37, characterized in that the cocatalyst is an alkyl of a metal from group III.

39. The catalytic system as claimed in claim 38, characterized in that the alkyl metal is chosen from trimethylaluminum, triethylaluminum and triisobutylaluminum, and combinations thereof.

40. The catalytic system as claimed in one of claims 37 to 39, characterized in that the catalytic electron donor(s) is (are) chosen from:
aliphatic silanes of general formula (VI)
SiR₁₄₄ (VI)
in which the radicals R¹⁴ each independently represent a C₁-C₂₀ alkyl group or an alkoxy group —OR¹⁵, R¹⁵ representing a C₁-C₂₀ alkyl group;
arylalkoxysilanes;
silacycloalkanes;
diethers of general formula (VII): 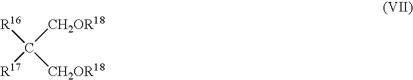
in which R¹⁶, R¹⁷ and R¹⁸, which may be identical or different, each represent a C₁-C₂₀ alkyl group; and
aminosilanes, such as those represented by general formulae (VIII) and (IX): 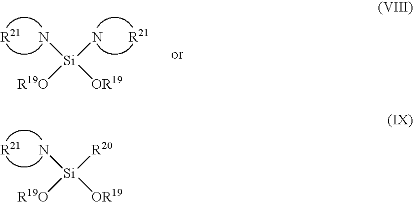
in which:
R¹⁹ represents an alkyl group containing from 1 to 8 carbon atoms;
R²⁰ represents an alkyl group containing from 2 to 24 carbon atoms and preferably from 2 to 8 carbon atoms, or a hydrocarbon-based amine group containing from 2 to 20 carbon atoms or an alkoxy group containing from 2 to 24 carbon atoms and preferably from 2 to 8 carbon atoms, or alternatively a hydrocarbon-based silicon group; and 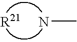
represents a polycyclic amino group for which the number of carbon atoms is between 7 and 40, and which forms a cyclic skeleton including the nitrogen atom.

41. A process for the homopolymerization of α-olefins and ethylene, in particular for the homopolymerization of propylene, or for the copolymerization of ethylene and α-olefins, which involves placing ethylene and/or at least one α-olefin and/or at least one other comonomer representing less than 50% by mass, in contact with a catalytic system as defined in one of claims 37 to 40, said process being performed in suspension or in the gas phase or in a liquid α-olefin.

42. The process as claimed in claim 40, characterized in that the α-olefin is propylene.
